(19) United States
(12) Patent Application Publication
(10) Pub. No.: US 2011/0181641 A1
(43) Pub. Date: Jul. 28, 2011

(54) IMAGE RECORDING APPARATUS

(75) Inventors: Takaya Kitawaki, Shizuoka-ken (JP); Yoshiaki Kaneko, Shizuoka-ken (JP); Takashi Kado, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/009,190

(22) Filed: Jan. 19, 2011

Related U.S. Application Data
(60) Provisional application No. 61/299,055, filed on Jan. 28, 2010.

(51) Int. Cl. B41J 29/38

(52) U.S. Cl. 347/9

(57) ABSTRACT

According to one embodiment, an image recording apparatus has a printing unit and a controller. The printing unit prints—using a removable color material. The controller is configured to control the printing unit to print images on a paper over plural passes in a divided manner.

### CROSS-REFERENCE TO RELATED APPLICATIONS

This application is based upon and claims the benefit of priority from Provisional Application No. 61/299,055, filed on Jan. 28, 2010, the entire contents of which are incorporated herein by reference.

### FIELD

Embodiments described herein relate generally to an ink jet recording apparatus which performs printing using a removable color material.

### BACKGROUND

At present, there are electro-photographic type image recording apparatuses including a printing unit which performs printing using color materials which are not removable by heat (hereinafter, referred to as “irremovable color materials”) and a printing unit which performs printing using color materials which are removable by heat (hereinafter, referred to as “removable color materials”). Images on a surface of paper, which are printed using the removable color materials, are removed by heat. Therefore, paper having undergone printing using the removable color materials can be reused. In terms of reducing the environmental impact, the ink jet recording apparatus which performs printing using color materials removable by heat is effective.

However, the paper deteriorates each time the printing and the color removal are repeated. If printing is performed on the surface of the paper deteriorated as described above, image quality on the surface of the paper also deteriorates.

### BRIEF DESCRIPTION OF THE DRAWINGS

FIG. 1 is an exemplary transversely sectional view of an ink jet recording apparatus according to an embodiment.

FIG. 2 is an exemplary block diagram illustrating a configuration of the ink jet recording apparatus according to the embodiment.

FIG. 3 is an exemplary flowchart illustrating a printing operation by the ink jet recording apparatus according to the embodiment.

FIG. 4 is an exemplary schematic diagram illustrating dot formation positions if printing is completed over one pass by the ink jet recording apparatus according to the embodiment.

FIGS. 5A, 5B and 5C are exemplary schematic diagrams illustrating dot formation positions if printing is completed over two passes by the ink jet recording apparatus according to the embodiment.

FIGS. 6A, 6B and 6C are exemplary schematic diagrams illustrating dot formation positions if printing is completed over three passes by the ink jet recording apparatus according to the embodiment.

FIGS. 7A, 7B and 7C are exemplary schematic diagrams illustrating dot formation positions if printing is completed over four passes by the ink jet recording apparatus according to the embodiment.

### DETAILED DESCRIPTION

In general, according to one embodiment, an image recording apparatus has a printing unit and a controller. The printing unit prints—using removable color materials. The controller is configured to control the printing unit to print images on paper over plural passes in a divided manner.

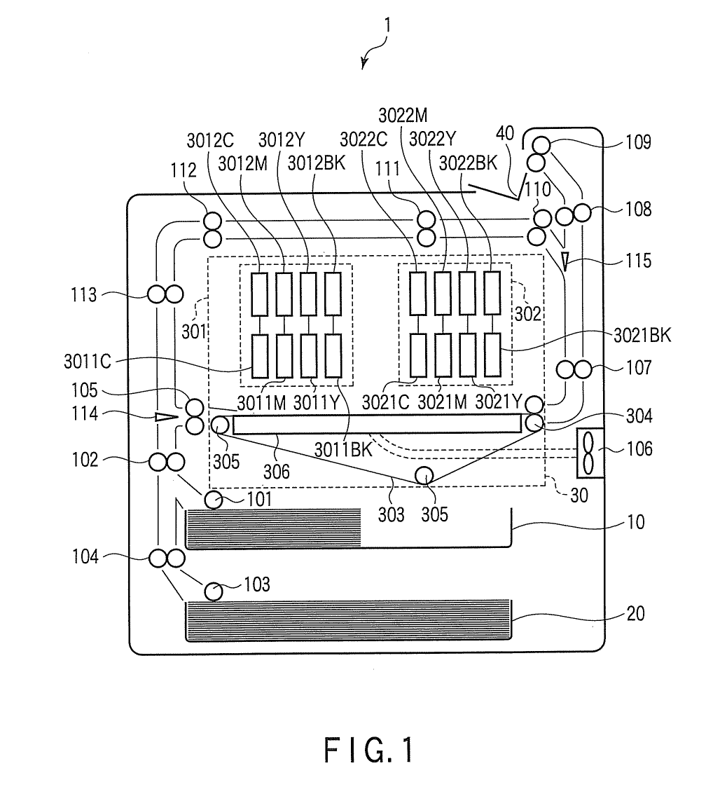

Hereinafter, this embodiment will be described with reference to the accompanying drawings. The embodiment will be described using an ink jet recording apparatus as the image recording apparatus. FIG. 1 is a transversely sectional view of an ink jet recording apparatus 1 according to the embodiment. The ink jet recording apparatus 1 includes a first paper cassette 10, a second paper cassette 20, an image forming portion 30, and a paper discharge tray 40. The first paper cassette 10 contains a bundle of paper constituted by plural sheets of paper (recording medium). The second paper cassette 20 contains a bundle of paper constituted by plural sheets of paper having a size different from the size of the paper contained in the first paper cassette 10. The ink jet recording apparatus 1 also has a paper feeding portion including a first paper feeding roller 101, a carrying roller pair 102, a second paper feeding roller 103, a carrying roller pair 104, and a resist roller pair 105, in order to carry the paper contained in the first paper cassette 10 or the second paper cassette 20 to the image forming portion 30.

The image forming portion 30 includes a first printing unit 301, a second printing unit 302, a carrying belt 303, a driving roller 304, driven rollers 305, and a negative pressure chamber 306.

The first printing unit 301 has ink jet recording heads 3011C, 3011M, 3011Y and 3011Bk of four lines which eject irremovable color materials (ink) on the paper according to printing data. The first printing unit 301 sequentially includes, from the upstream side in a carrying direction of the paper, the ink jet recording head 3011C which ejects irremovable cyan (C) ink, the ink jet recording head 3011M which ejects irremovable magenta (M) ink, the ink jet recording head 3011Y which ejects irremovable yellow (Y) ink, and the ink jet recording head 3011Bk which ejects irremovable black (Bk) ink. In the respective ink jet recording heads 3011C, 3011M, 3011Y and 3011Bk, nozzles ejecting ink droplets are disposed with a predetermined resolution in a width direction perpendicular to the carrying direction of the paper. That is to say, each of the ink jet recording heads 3011C, 3011M, 3011Y and 3011Bk is a line head where a plurality of nozzles are disposed in a line.

The ink jet recording head 3011C and an ink cartridge 3012C, the ink jet recording head 3011M and an ink cartridge 3012M, the ink jet recording head 3011Y and an ink cartridge 3012Y, and the ink jet recording head 3011Bk and an ink cartridge 3012Bk are respectively connected to each other via tubes. Each of the cyan (C) ink cartridge 3012C, the magenta (M) ink cartridge 3012M, the yellow (Y) ink cartridge 3012Y, and the black (Bk) ink cartridge 3012Bk is filled with the respective irremovable color material therein.

The second printing unit 302 is positioned at the downstream side of the first printing unit 301 in the carrying direction of the paper. The second printing unit 302 sequentially includes, from the upstream side in the carrying direction of the paper, an ink jet recording head 3021C which ejects removable cyan (C) ink, an ink jet recording head 3021M which ejects removable magenta (M) ink, an ink jet recording head 3021Y which ejects removable yellow (Y) ink, and an ink jet recording head 3021Bk which ejects removable black (Bk) ink. In the respective ink jet recording heads 3021C, 3021M, 3021Y and 3021Bk, nozzles ejecting ink droplets are disposed with a predetermined resolution in a width direction perpendicular to the carrying direction of the paper. That is to say, each of the ink jet recording heads 3021C, 3021M, 3021Y and 3021Bk is a line head where a plurality of nozzles are disposed in a line.

The ink jet recording head 3021C and an ink cartridge 3022C, the ink jet recording head 3021M and an ink cartridge 3022M, the ink jet recording head 3021Y and an ink cartridge 3022Y, and the ink jet recording head 3021Bk and an ink cartridge 3022Bk are respectively connected to each other via tubes. Each of the cyan (C) ink cartridge 3022C, the magenta (M) ink cartridge 3022M, the yellow (Y) ink cartridge 3022Y, and the black (Bk) ink cartridge 3022Bk is filled with the respective removable color material therein.

The ink jet recording apparatus 1 may include only the second printing unit 302. In the ink jet recording apparatus 1, the first printing unit 301 may be positioned downstream of the second printing unit 302 in the carrying direction of the paper. The first printing unit 301 may include only the ink jet recording heads 3011C, 3011M and 3011Y for color printing, and include only the ink jet recording head 3011Bk for monochrome printing. Likewise, the second printing unit 302 may include only the ink jet recording heads 3021C, 3021M and 3021Y for color printing, and include only the ink jet recording head 3021Bk for monochrome printing.

In addition, the ink jet recording heads 3011C, 3011M, 3011Y and 3011Bk may be line heads having a size equal to or greater than a width size of paper which can be contained in the first paper cassette 10 or the second paper cassette 20. This is true of the ink jet recording heads 3021C, 3021M, 3021Y and 3021Bk. A nozzle pitch of each of the ink jet recording heads 3011C, 3011M, 3011Y and 3011Bk may be larger than a nozzle pitch of each of the ink jet recording heads 3021C, 3021M, 3021Y and 3021Bk. The nozzle pitch of each of the ink jet recording heads 3011C, 3011M, 3011Y and 3011Bk may be the same as the nozzle pitch of each of the ink jet recording heads 3021C, 3021M, 3021Y and 3021Bk.

The carrying belt 303 is hung between the driving roller 304 and the two driven rollers 305 in an endless manner. The carrying belt 303 receives tension from the driving roller 304 and the two driven rollers 305. A surface of the carrying belt 303 has holes with a predetermined interval. The negative pressure chamber 306 is positioned inside the carrying belt 303. The negative pressure chamber 306 is connected to a fan 106 such that the paper adheres to the carrying belt 303.

A gap between an end portion facing the carrying belt 303 of each of the ink jet recording heads 3011C, 3011M, 3011Y and 3011Bk and the ink jet recording heads 3021C, 3021M, 3021Y and 3021Bk and a surface of the paper is maintained to be constant by the negative pressure chamber 306. Images are formed on the surface of the paper by the first printing unit 301 or the second printing unit 302 at a desired position.

In order to carry the paper from the image forming portion 30 to the paper discharge tray 40, the ink jet recording apparatus 1 has a discharge portion which sequentially includes a carrying roller pair 107, a carrying roller pair 108, and a paper discharge roller pair 109 from the image forming portion 30 to the paper discharge tray 40. The paper discharge tray 40 contains plural sheets of paper, discharged from the paper discharge roller pair 109, on which printing is completed in a stacked manner one after the other.

Also, the ink jet recording apparatus 1 has a circulating path (carrying portion) provided at an upper part with respect to the carrying belt 303, which includes a carrying roller pair 110, a carrying roller pair 111, a carrying roller pair 112, and a carrying roller pair 113, in order to return the paper from the downstream side to the upstream side in the carrying direction of the paper in the image forming portion 30. The number of the carrying roller pairs in the circulating path is not limited thereto. In addition, the circulating path is constituted by a plurality of carrying roller pairs, and further, may be a turntable installed in the same plane as the carrying belt 303.

The ink jet recording apparatus 1 has a first flapper 114 and a second flapper 115. The first flapper 114 is positioned at the upstream side of the resist roller pair 105 in the carrying direction of the paper. The first flapper 114 is positioned so as to form either a path where the paper contained in the first paper cassette 10 or the second paper cassette 20 is carried to the resist roller pair 105, or a path where the paper having undergone printing in the image forming portion 30 is carried to the resist roller pair 105 again. The first flapper 114 alters a direction of a guide front end with respect to a fulcrum (not shown). The second flapper 115 is positioned at the downstream side of the carrying roller pair 107 in the carrying direction of paper. The second flapper 115 is positioned so as to form either a path where the paper is carried to the paper discharge tray 40 or a path where the paper on which images are formed in the image forming portion 30 is carried to the resist roller pair 105 again. The second flapper 115 alters a guide front end with respect to a fulcrum (not shown).

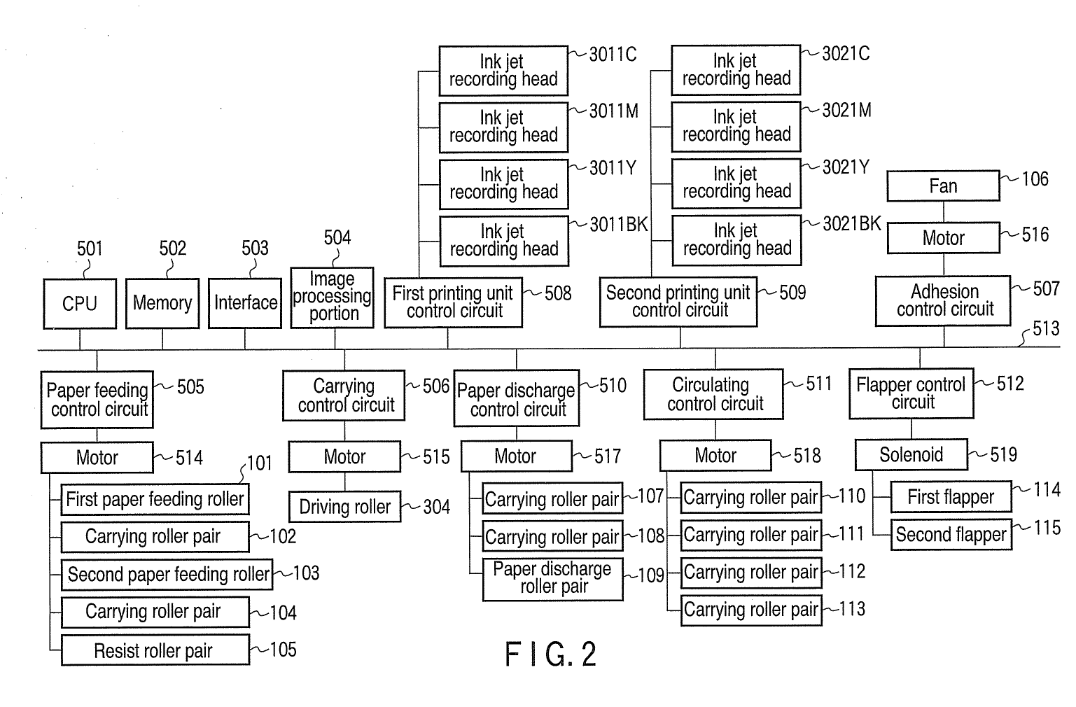

FIG. 2 is a block diagram illustrating a control system of the ink jet recording apparatus 1 according to the embodiment. The ink jet recording apparatus 1 includes a CPU 501 which is a processor, a memory 502, an interface 503, an image processing portion 504, a paper feeding control circuit 505, a carrying control circuit 506, an adhesion control circuit 507, a first printing unit control circuit 508, a second printing unit control circuit 509, a paper discharge control circuit 510, a circulating control circuit 511, and a flapper control circuit 512. They are respectively connected to each other via a CPU bus 513. The CPU 501 is a microprocessor and performs various kinds of operational processes.

The CPU 501 controls operations of the respective portions connected via the CPU bus 513. The memory 502 stores various kinds of programs executed by the CPU 501 and various kinds of data. The interface 503 connects an external computer to the CPU bus 513. The interface 503 enables a printing command and an image signal to be input to the ink jet recording apparatus 1 from the external computer. The image processing portion 504 performs an image processing for the input image signal. Thereafter, the image processing portion 504 converts the image signal into printing data suitable for printing by the image forming portion 30.

The paper feeding control circuit 505 controls driving of a motor 514 under the control of the CPU 501. The motor 514 drives the first paper feeding roller 101, the carrying roller pair 102, the second paper feeding roller 103, the carrying roller pair 104, and the resist roller pair 105 independently. The carrying control circuit 506 controls driving of a motor 515 under the control of the CPU 501. The motor 515 drives the driving roller 304. The adhesion control circuit 507 controls driving of a motor 516 under the control of the CPU 501. The motor 516 drives the fan 106.

The first printing unit control circuit 508 controls the ink jet recording heads 3011C, 3011M, 3011Y and 3011Bk to eject ink based on the printing data under the control of the CPU 501. The first printing unit control circuit 508 controls the ink jet recording heads 3011C, 3011M, 3011Y and 3011Bk to eject ink in synchronization with a carrying operation of paper by the carrying belt 303. The second printing unit control circuit 509 controls the ink jet recording heads 3021C, 3021M, 3021Y and 3021Bk to eject ink in synchronization with the carrying operation of paper by the carrying belt 303.

The paper discharge control circuit 510 controls driving of a motor 517 under the control of the CPU 501. The motor 517 drives the carrying roller pair 107, the carrying roller pair 108, and the paper discharge roller pair 109 independently. The circulating control circuit 511 controls driving of a motor 518 under the control of the CPU 501. The motor 518 drives the carrying roller pair 110, the carrying roller pair 111, the carrying roller pair 112, and the carrying roller pair 113 independently. The flapper control circuit 512 controls driving of a solenoid 519 under the control of the CPU 501. The solenoid 519 drives the first flapper 114 and the second flapper 115 independently.

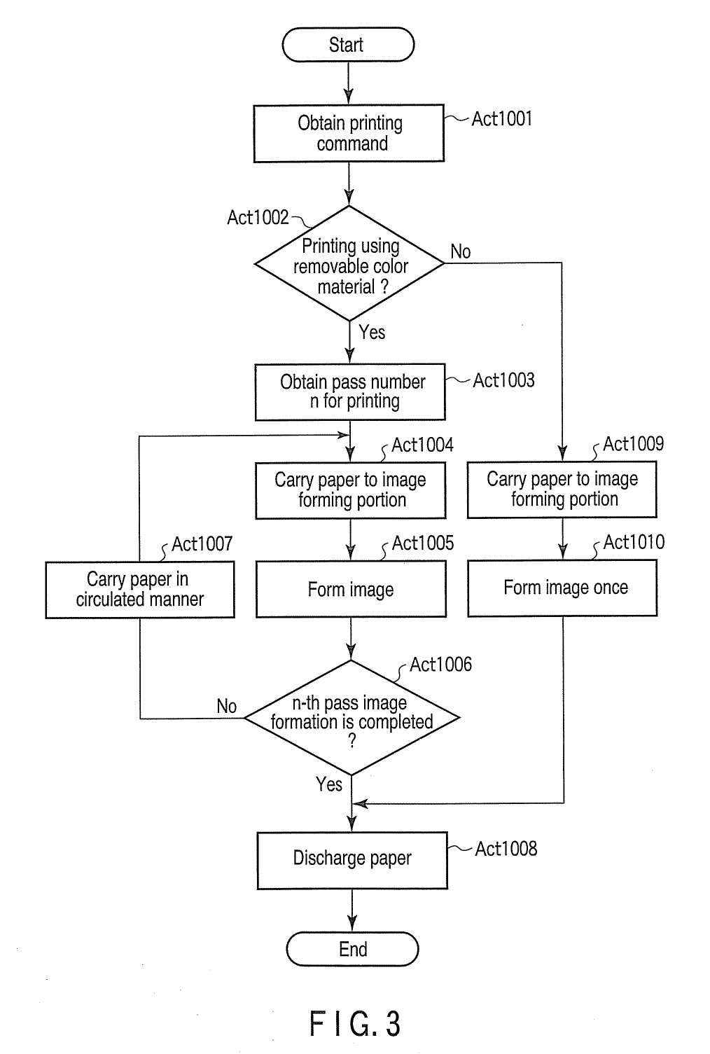

FIG. 3 is a flowchart illustrating a printing operation by the ink jet recording apparatus 1. First, the CPU 501 obtains a printing command from the external computer via the interface 503 (Act 1001). The printing command includes size information for paper undergoing printing. Printing information includes color or monochrome information for color printing or monochrome printing. The printing information includes color material information for either printing using irremovable color materials or printing using removable color materials. Also, the printing information includes pass number information regarding over which passes printing is performed if the printing is performed using the removable color materials. The CPU 501 obtains such information from the printing command.

The CPU 501 determines whether or not printing using the removable color materials is requested based on the color material information included in the printing command (Act 1002). If the printing using the removable color materials is requested (Act 1002, Yes), the CPU 501 obtains the number of passes n (n≧2) during the printing based on the pass number information included in the printing command (Act 1003). That is to say, the second printing unit 302 completes image formation on paper with printing n times in a divided manner.

Next, the CPU 501 controls such that the paper is carried to the image forming portion 30 (Act 1004). Here, the CPU 501 controls such that paper having a size based on the size information for paper included in the printing command is carried to the image forming portion 30 from the first paper cassette 10 or the second paper cassette 20. For example, if paper is carried to the image forming portion 30 from the first paper cassette 10, the CPU 501 controls such that the paper is carried to the resist roller pair 105 using the first paper feeding roller 101 and the carrying roller pair 102. Likewise, if paper is carried to the resist roller pair 105 from the second paper cassette 20, the CPU 501 controls such that the paper is carried to the resist roller pair 105 using the second paper feeding roller 103 and the carrying roller pair 104. Thereafter, the CPU 501 controls such that the paper is carried on the carrying belt 303 of the image forming portion 30 using the resist roller pair 105 (Act 1004).

The CPU 501 controls such that the paper is carried from a position of the ink jet recording head 3021C to a position of the ink jet recording head 3021Bk, at a position facing the second printing unit 302, using the carrying belt 303 (carrying portion). The CPU 501 controls such that an m-th (m≦n) printing pass is performed on the surface of the paper, using the second printing unit 302, based on the printing data processed by the image processing portion 504 (Act 1005). At this time, the CPU 501 performs color or monochrome printing using the second printing unit 302 based on the color or monochrome information included in the printing command.

If the second printing unit 302 finishes the m-th pass printing, the CPU 501 determines whether or not an n-th (=m) pass printing is completed (Act 1006). If the n-th pass printing is not completed (Act 1006, No), the CPU 501 controls such that the paper on which the m-th pass printing is completed by the second printing unit 302 is carried to the upstream side of the resist roller pair 105 via the carrying roller pairs 110 to 113 in the circulating manner (Act 1007). At this time, the CPU 501 controls the first flapper 114 and the second flapper 115 to alter their positions such that the paper is circulated via the circulating path from the downstream side of the second printing unit 302 to the upstream side of the resist roller pair 105. The CPU 501 controls such that the paper is supplied to the resist roller pair 105 via the carrying roller pair 110, the carrying roller pair 111, the carrying roller pair 112, and the carrying roller pair 113. Thereafter, the CPU 501 returns to Act 1004, where it controls such that the paper is carried on the carrying belt 303 of the image forming portion 30 using the resist roller pair 105.

If the n-th pass printing is completed (that is, if image formation is completed by printing n times) (Act 1006, No), the CPU 501 controls such that the paper on which the m-th pass printing is completed by the second printing unit 302 is carried to the paper discharge tray 40 (Act 1008). At this time, the CPU 501 controls the second flapper 115 to alter its position such that the paper is carried from the downstream side of the second printing unit 302 to the paper discharge tray 40. The CPU 501 controls such that the paper is carried to the paper discharge tray 40 via the carrying roller pair 107, the carrying roller pair 108, and the paper discharge roller pair 109.

If printing using the removable color materials is not requested (in other words, printing using the irremovable color materials is requested) (Act 1002, No), the CPU 501 controls such that the paper is carried to the image forming portion 30 (Act 1009). The CPU 501 works in the same manner as in Act 1004. The CPU 501 controls such that the paper is carried from a position of the ink jet recording head 3011C to a position of the ink jet recording head 3011Bk, at a position facing the first printing unit 301, using the carrying belt 303. The CPU 501 controls such that printing is performed once on the surface of the paper, using the first printing unit 301, based on the printing data processed by the image processing portion 504 (Act 1010). That is to say, the printing by the first printing unit 301 completes image formation on the paper over one printing. At this time, the CPU 501 performs color or monochrome printing using the first printing unit 301 based on the color or monochrome information included in the printing command. Thereafter, the CPU 501 controls such that the paper on which the printing is completed by the first printing unit 301 is carried to the paper discharge tray 40 in Act 1008.

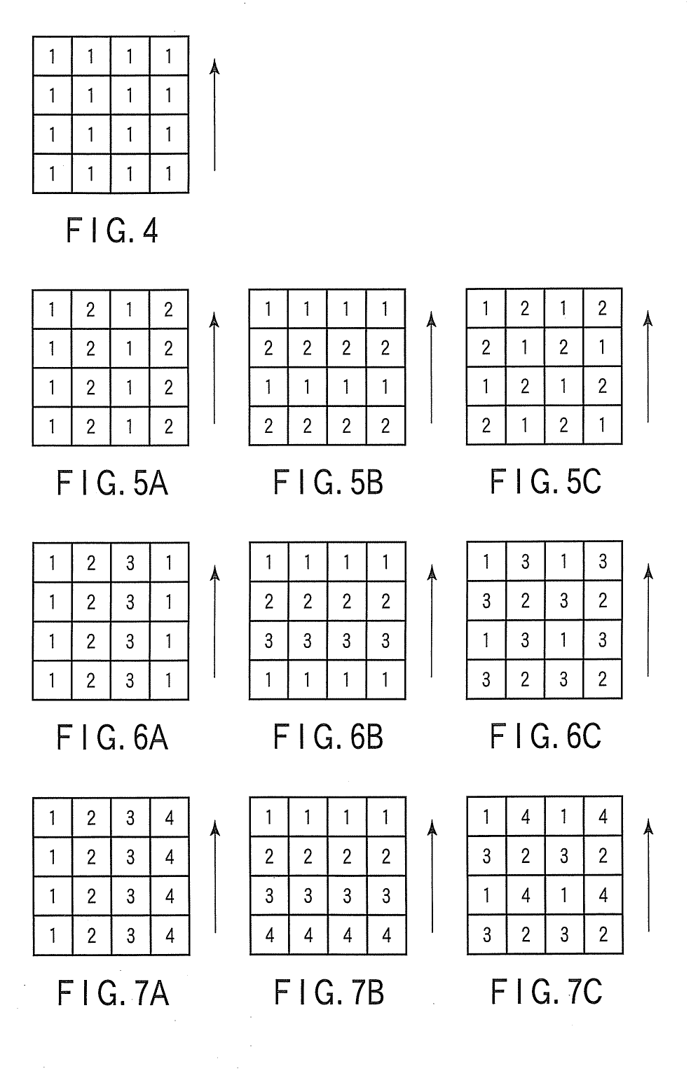

Next, the printing operation in Act 1005 by the second printing unit 302 will be described. FIG. 4 is a schematic diagram illustrating dot formation positions on paper if the second printing unit 302 completes image formation over one printing (here, referred to as “one-pass printing”), as a comparative example. An arrow denotes the carrying direction of paper. One cell indicates one dot printed on the paper. The numeral in the cell indicates at which pass the second printing unit 302 performs printing on the paper. In the example shown in FIG. 4, the CPU 501 controls the second printing unit 302 to complete image formation over one printing such that all the dots are printed on the paper at the first pass.

FIGS. 5A, 5B and 5C are schematic diagrams illustrating dot formation positions on the paper if the second printing unit 302 completes image formation over two printings (here, referred to as two-pass printing). The arrows denote the carrying direction of paper. One cell indicates one dot printed on the paper. The numeral in the cell indicates at which pass the second printing unit 302 performs printing on the paper. In the examples shown in FIGS. 5A, 5B and 5C, the CPU 501 controls the second printing unit 302 to print a half of all the dots which are printed on the entire paper at the first pass and second pass, respectively. In addition, the second printing unit 302 respectively prints dots at arbitrary positions at the first and second passes. For example, as shown in FIG. 5A, the dot formation positions may be alternately present at the first and second passes by one line in parallel to the carrying direction of paper. For example, as shown in FIG. 5B, the dot formation positions may be alternately present at the first and second passes by one line in the direction perpendicular to the carrying direction of paper. For example, as shown in FIG. 5C, the dot formation positions may be alternately present at the first and second passes by one dot so as not to be adjacent to each other.

FIGS. 6A, 6B and 6C are schematic diagrams illustrating dot formation positions on the paper if the second printing unit 302 completes image formation over three printings (here, referred to as three-pass printing). The arrows denote the carrying direction of paper. One cell indicates one dot printed on the paper. The numeral in the cell indicates at which pass the second printing unit 302 performs printing on the paper. In the examples shown in FIGS. 6A, 6B and 6C, the CPU 501 controls the second printing unit 302 to print a third of all the dots which are printed on the entire paper at the first pass, second pass, and third pass, respectively. In addition, the second printing unit 302 respectively prints dots at arbitrary positions at the first, second, and third passes. The dot formation positions shown in FIGS. 6A, 6B and 6C are the same as the dot formation positions shown in FIGS. 5A, 5B and 5C, respectively.

FIGS. 7A, 7B and 7C are schematic diagrams illustrating dot formation positions on the paper if the second printing unit 302 completes image formation over four printings (here, referred to as four-pass printing). The arrows denote the carrying direction of paper. One cell indicates one dot printed on the paper. The numeral in the cell indicates at which pass the second printing unit 302 performs printing on the paper. In the examples shown in FIGS. 7A, 7B and 7C, the CPU 501 controls the second printing unit 302 to print a fourth of all the dots which are printed on the entire paper at the first pass, second pass, third pass, and fourth pass, respectively. In addition, the second printing unit 302 respectively prints dots at arbitrary positions at the first, second, third, and fourth passes. The dot formation positions shown in FIGS. 7A, 7B and 7C are the same as the dot formation positions shown in FIGS. 6A, 6B and 6C, respectively.

Here, there is a comparison of an ink amount (volume) per unit area between the one pass printing and the plural-pass printing under the condition that the same image is printed on paper with the same quality (image quality). The ink amount used in the two-pass printing decreases by about 20% as compared with the ink amount used in the one pass printing. The ink amount used in the three-pass printing decreases by about 25% as compared with the ink amount used in the one pass printing. The ink amount used in the four-pass printing decreases by about 30% as compared with the ink amount used in the one pass printing. That is to say, the ink amount used in a n-pass printing gradually decreases as compared with the ink amount used in the one pass printing, as n increases. This results from printing with the number of n times with intervals if the n-pass printing is performed. Therefore, the CPU 501 controls such that an ink amount per one dot ejected from each nozzle of the second printing unit 302 for each pass is changed, based on the pass number information included in the printing request. In addition, for example, if the four-pass printing is performed, the ink amount per one dot ejected from each nozzle of the second printing unit 302 may be the same or different at each of the first, second, third, and fourth passes. Although the image recording apparatus is described as the ink jet recording apparatus, it is not limited thereto, but may be an electro-photographic type recording apparatus.

According to this embodiment, if the printing is performed using the removable color materials, it is possible to reduce the ink amount per unit area. Therefore, deterioration in paper during the printing using the removable color materials decreases. As a result, deterioration in image quality on a surface of the paper decreases.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image recording apparatus comprising:
a first printing unit printing using a removable color material; and
a controller configured to control the first printing unit to print images on a paper over plural passes in a divided manner.

2. The apparatus of claim 1, wherein the first printing unit is an ink jet type printing unit.

3. The apparatus of claim 2, wherein the controller controls the first printing unit such that an amount per unit area of the removable color material ejected from the first printing unit decreases as a number of the plural passes increases.

4. The apparatus of claim 2, wherein the first printing unit performs color printing.

5. The apparatus of claim 2, wherein the first printing unit performs monochrome printing.

6. The apparatus of claim 2, further comprising a circulating path from a downstream side to an upstream side of the first printing unit in a carrying direction of a paper.

7. The apparatus of claim 6, wherein the controller controls such that a paper printed by the first printing unit is circulated via the circulating path.

8. The apparatus of claim 2, further comprising a second printing unit which is an ink jet type configured to perform printing using an irremovable color material.

9. The apparatus of claim 8, wherein the second printing unit is positioned at the downstream side of the first printing unit in the carrying direction of a paper.

10. The apparatus of claim 8, wherein the controller controls a number of passes over which the second printing unit performs printing to be equal to or less than a number of passes over which the first printing unit performs printing.

11. The apparatus of claim 10, wherein the number of passes over which the second printing unit performs printing is one.

12. The apparatus of claim 8, wherein a nozzle pitch of each ink jet head of the first printing unit is larger than a nozzle pitch of each ink jet head of the second printing unit.

13. An image recording method comprising:
receiving a request for printing; and
printing a first printing unit which performs printing using a removable color material to print images on a paper over plural passes in a divided manner.

14. The method of claim 13, wherein the first printing unit is an ink jet type printing unit.

15. The method of claim 14, further comprising controlling an amount per unit area of the removable color material ejected from the first printing unit to decrease as a number of the plural passes increases.

16. The method of claim 14, further comprising causing a second printing unit which is an ink jet type and performs printing using an irremovable color material to print images on a paper.

17. The method of claim 16, further comprising controlling a number of passes over which the second printing unit performs printing to be equal to or less than a number of passes over which the first printing unit performs printing.
